(19) United States
(12) Patent Application Publication
(10) Pub. No.: US 2015/0289170 A1
(43) Pub. Date: Oct. 8, 2015

(54) SUBSCRIBER NODE AND SHARED NETWORK

(71) Applicant: TELEFONAKTIEBOLAGET L M ERICSSON (PUBL), Stockholm (SE)

(72) Inventors: Josefin Karlsson, Torslanda (SE); Roland Gustafsson, Bengtsfors (SE); Peter Ramle, Molnlycke (SE); Paul Schliwa-Bertling, Ljungsbro (SE)

(21) Appl. No.: 14/440,469

(22) PCT Filed: Nov. 4, 2013
(86) PCT No.: PCT/EP2013/072940

§ 371 Date: May 4, 2015

Related U.S. Application Data
(60) Provisional application No. 61/722,275, filed on Nov. 5, 2012.

(51) Int. Cl. H04W 36/00; H04W 48/18; H04W 36/14; H04W 64/00; H04W 4/02

(52) U.S. Cl. CPC H04W 36/0022; H04W 64/003; H04W 4/02; H04W 36/14; H04W 48/18

(57) ABSTRACT

The embodiments herein relate to a method in a target RAN node (105t) for handling selection of a serving operator for a wireless device (101) which has been handed over from a source network to a target shared network (100). The target RAN node (105t) requests an IMSI from a target CN node (110ta) in a same domain that an incoming mobility message is considered for. The target RAN node (105t) receives the requested IMSI. The response further comprises either a used serving operator or an address of a used CN node (110tb). The used serving operator and the used CN node (110tb) are used in another domain than the do main that the incoming mobility message is considered for. The target RAN node (105t) selects the serving operator for the domain that the incoming mobility message is considered for to be the same as indicated for the other domain.

### TECHNICAL FIELD

Embodiments herein relate generally to a target Radio Access Network (RAN) node and a method in the target RAN node, a target Core Network (CN) node and a method in the target CN node, a used CN Node and a method in the used CN node, a subscriber node and a method in the subscriber node. More particularly the embodiments herein relate to Circuit Switched/Packet Switched (CSPS) coordination in a shared network using a subscriber node and related to handling selection of a serving operator for a wireless device which has been handed over from a source network to a target shared network.

### BACKGROUND

In a typical communications network, also referred to as e.g. a wireless communications network, a wireless communications system, a communications network or a communications system, a wireless device, communicates via a RAN to one or more CNs.

The wireless device may be a device by which a subscriber may access services offered by an operator's network and services outside the operator's network to which the operator's radio access network and core network provide access, e.g. access to the Internet. The wireless device may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device or any type of consumer electronic, for instance but not limited to television, radio, lighting arrangements, tablet computer, laptop or Personal Computer (PC). The wireless device may be portable, pocket storable, hand held, computer comprised, or vehicle mounted devices, enabled to communicate voice and/or data, via the radio access network, with another entity, such as another device or a server.

Wireless devices are enabled to communicate wirelessly in the communications network. The communication may be performed e.g. between two wireless devices, between a devices and a regular telephone and/or between the wireless devices and a server via the radio access network and possibly one or more core networks and possibly the Internet.

The communications network serves a geographical area which is divided into cell areas, with each cell area being served by a base station, e.g. a Radio Base Station (RBS), which in some radio access networks is also called evolved NodeB (eNB), NodeB, B node or base station. A cell is a geographical area where radio coverage is provided by the radio base station at a base station site. The base stations communicate with the wireless devices within range of the base stations.

A Third Generation Partnership Project (3GPP) network may be organized using network sharing. A shared network allows different core network operators to connect to a shared RAN. The operators share the radio network elements, and may also share the radio resources. The target shared network is shared between CN operators. To handle network sharing, the 3GPP standard has introduced support for Multi Operator Core Network (MOON) and Gateway Core Network (GWCN) (see 3GPP TS 23.251) which provides means to share a RAN between multiple operators. When a wireless device is a non-supporting wireless device, the RAN is responsible for the selection of the CN node when the wireless device performs registration procedures like e.g. Location Area Update (LAU), Routing Area Update (RAU) or combined RAU/LAU. In the Release-10 of the 3GPP specification, new procedures for Global System for Mobile communication (GSM) have been introduced to re-route a registration to another CN node if the initial selection performed by the RAN was incorrect (see 3GPP TS 23.251). Corresponding procedures for Wideband Code Division Multiple Access (WCDMA) was introduced before Release-6 of the 3GPP specification.

When the wireless device is moving, it may be handed over from a source network to a target network, e.g. from a source RAN node to a target RAN node. At handover, the connections between the wireless device and the source network are handed over to the target network.

Circuit Switching is a methodology of implementing the communications network in which two network nodes establish a dedicated communications channel (circuit) through the communications network before the network nodes may communicate. The circuit functions as if the nodes were physically connected as with an electrical circuit. An example of a circuit switched network is the Public Switched Telephone Network (PSTN).

Circuit switching contrasts with packet switching which divides the data to be transmitted into small units, called packets, transmitted through the network independently. Packet switching shares available network bandwidth between multiple communication sessions. Packet switching features delivery of variable bit rate data streams (sequences of packets) over a shared network. When traversing network adapters, switches, routers and other network nodes, packets are buffered and queued, resulting in variable delay and throughput depending on the traffic load in the network.

In 3GPP today there are mobility situations when the wireless device moves from a source side which can be Universal Terrestrial Radio Access Network (UTRAN), Evolved-Universal Terrestrial Radio Access Network (E-UTRAN), GSM EDGE Radio Access Network (GERAN) or another access to a target GERAN shared network or target UTRAN shared network. EDGE is short for Enhanced Data rates for GSM Evolution. The source side can be either a shared network or a non-shared network. The mobility can be either connected mode mobility or idle mode mobility.

In conventional networks, the same core network operator may always serve the wireless device in CS and PS domains. In a shared network, supporting wireless devices shall behave as wireless devices in conventional networks with respect to registration with CS and PS domains. A conventional network is defined by the 3GPP as a Public Land Mobile Network (PLMN) consisting of a RAN and a CN, by which only one serving operator provides services to its subscriber. Subscribers of other operators may receive services by national or international roaming.

PLMN, as mentioned above, is a network with the objective of providing wireless communication and to interlink the wireless network with the fixed wired network. A PLMN is identified by a PLMN ID comprising a Mobile Country Code (MCC) and a Mobile Network Code (MNC). Each operator providing mobile services may have its own PLMN. PLMNs interconnect other PLMNs and PSTNs for telephone communications or with Internet service providers for data and Internet access of which links are defined as interconnect links between providers.

CS/PS coordination may be described as a method for coordinating the registration of a device in circuit switched and packet switched domains of a MOON or GWCN network. CS/PS coordination is achieved when the same operator is simultaneously serving the device in both the CS domain and the PS domain.

In 3GPP today there are situations where CS/PS coordination is not achieved. Such situations may be when the shared network only supports non-supporting wireless devices or when the wireless device is a GERAN or UTRAN non-supporting wireless device. A problem is that PS operator and CS operator is selected at different networks, one operator is selected on the source side while the other is selected in the target side and thus there is no common synchronization place.

The PS/CS coordination problems may occur in idle mode mobility, in PS handover or CS handover, in non-DTM or DTM case, in MOON or a GWCN shared network. DTM is short for dual transfer mode and is a protocol that makes it possible for a wireless device to simultaneous transfer CS voice and PS data.

### SUMMARY

An objective of embodiments herein is therefore to obviate at least one of the above disadvantages and to provide improved handling of serving operators in a target shared network.

According to a first aspect, the object is achieved in a target RAN node for handling selection of a serving operator for a wireless device which has been handed over from a source network to a target shared network. When the wireless device has been handed over to the target shared network, the target RAN node requests an International Mobile Subscriber Identity (IMSI) for the wireless device from a target CN node in a same domain that an incoming mobility message is considered for. The target RAN node receives a response comprising the requested IMSI from the target CN node. The response further comprises either a used serving operator or an address of a used CN node. The used serving operator and the used CN node are used in another domain than the domain that the incoming mobility message is considered for. The target RAN node selects the serving operator for the domain that the incoming mobility message is considered for to be the same as indicated for the other domain.

According to a second aspect, the objective is achieved by a method in the target CN node for handling selection of the serving operator for the wireless device which has been handed over from the source network to the target shared network. The target CN node is in the same domain as the incoming mobility message is considered for by the target RAN node. When the wireless device has been handed over to the target shared network, the target CN node receives, from the target RAN node, the request for the IMSI for the wireless device. The target CN node retrieves the IMSI. The target CN node transmits, to a subscriber node, a request for the used serving operator or the address of the used CN node. The request comprises the IMSI. The serving operator and the used CN node is for another domain than the domain that the incoming mobility message is considered for. The target CN node receives, from the subscriber node, a response comprising the used serving operator or the address of the used CN node. The target CN node transmits the response comprising the IMSI to the target RAN node. The response further comprises information indicating the used serving operator or the address of the used CN node.

According to a third aspect, the objective is achieved by a method in the used CN node for handling selection of the serving operator for the wireless device which has been handed over from the source network to the target shared network. The used CN node is used in another domain than what the incoming mobility message is considered for by the target RAN node. The used CN node receives, from the RAN node, the request for information indicating the used serving operator. The used serving operator is used in the other domain. The used CN node transmits the response to the RAN node including information indicating the used serving operator which serves the wireless device in the other domain.

According to a fourth aspect, the objective is achieved by a method in the subscriber node for handling selection of the serving operator for the wireless device which has been handed over from the source network to the target shared network. The subscriber node receives, from the target CN node, the request for the used serving operator or the address of the used CN node. The request comprises the IMSI for the wireless device. The used serving operator and the used CN node is for another domain than the domain which the incoming mobility message is considered for by the target RAN node. The subscriber node transmits, to the target CN node, the response comprising the used serving operator or the address of the used CN node of the other domain.

According to a fifth aspect, the objective is achieved by the target RAN node for handling selection of the serving operator for the wireless device which has been handed over from the source network to the target shared network. The target RAN node comprises a transmitter which is adapted to, when the wireless device has been handed over to the target shared network, request the IMSI for the wireless device from the target CN node in the same domain that the incoming mobility message is considered for. The target RAN node comprises a receiver which is adapted to receive, a response comprising the requested IMSI from the target CN node. The response further comprises either the used serving operator or the address of the used CN node. The used serving operator and the used CN node are used in another domain than the domain that the incoming mobility message is considered for. The target RAN node comprises a processor which is adapted to select the serving operator for the domain that the incoming mobility message is considered for to be the same as indicated for the other domain.

According to a sixth aspect, the objective is achieved by the target CN node for handling selection of the serving operator for the wireless device which has been handed over from the source network to the target shared network the target CN node is in the same domain as the incoming mobility message is considered for by the target RAN node. The target CN node comprises a receiver adapted to, when the wireless device has been handed over to the target shared network, receive, from the target RAN node, a request for the IMSI for the wireless device. The target CN node comprises a processor which is adapted to retrieve the IMSI. The target CN node comprises a transmitter adapted to transmit, to the subscriber node, the request for the used serving operator or the address of the used CN node. The request comprises the IMSI. The serving operator and the used CN node is for another domain than the domain that the incoming mobility message is considered for. The receiver is further adapted to receive the response comprising the used serving operator or the address of the used CN node. The transmitter is further adapted to transmit the response comprising the IMSI to the target RAN node. The response further comprises information indicating the used serving operator or the address of the used CN node.

According to a seventh aspect, the objective is achieved by the used CN node for handling selection of the serving operator for the wireless device which has been handed over from the source network to the target shared network. The used CN node is used in another domain than what the incoming mobility message is considered for by the target RAN node. The used CN node comprises a receiver which is adapted to receive, from the RAN node, the request for information indicating the used serving operator. The used serving operator is used in the other domain. The used CN node comprises a transmitter which is adapted to transmit a response to the RAN node including information indicating the used serving operator which serves the wireless device in the other domain.

According to an eight aspect, the objective is achieved by the subscriber node which is adapted to handling selection of the serving operator for the wireless device which has been handed over from the source network to the target shared network. The subscriber node comprises a receiver which is adapted to receive, from the target CN node, the request for the used serving operator or the address of the used CN node. The request comprises the IMSI for the wireless device. The used serving operator and the used CN node is for another domain than the domain which the incoming mobility message is considered for by the target RAN node. The subscriber node comprises a transmitter which is adapted to transmit, to the target CN node, a response comprising the used serving operator or the address of the used CN node of the other domain.

For situations such as when the wireless device performs PS handover to GERAN/UTRAN shared network, the source CN node retrieves the operator indicated during the handover procedure and uses this operator for the other domain (PS domain or CS domain). For example in the case of a PS handover, the PS operator is currently known by the Serving General packet radio service Support Node (SGSN) and when the wireless device enters idle mode in the target CS domain and then performs a LAU procedure, the CS operator is not known by the Base Station Controller (BSC). This may be achieved by the BSC first requesting the IMSI for the subscriber by a request to a Mobile Switching Center (MSC) (this can be any of the MSCs). The MSC retrieves the IMSI and requests the subscriber node such as e.g. a Home Location Register (HLR) or a Home Subscriber Server (HSS), for this subscriber of either the used PS operator or the used SGSN(s) for this subscriber. The HLR/HSS responds back to the MSC with this information and the MSC responds back to the BSC with this information. If the BSC has got the PS operator, then the same operator is used in the CS domain. If the response from MSC includes information of the used SGSN, the BSC sends a request to this SGSN to request the used PS operator for the subscriber.

The BSC selects the CS operator to be the same operator as the used PS operator. The BSC sends a LAU Request to an MSC representing this operator (in case of MOCN). I case of GWCN, the BSC also includes the operator to be used to the MSC when a LAU Request is sent to the MSC.

Embodiments herein afford many advantages, of which a non-exhaustive list of examples follows:

An advantage of the embodiments herein is that after concluded handover and idle mode mobility has occurred in the other domain (CS domain), the subscriber is using the same CS operator and PS operator.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating embodiments of a communications network.

FIG. 2 is a signaling diagram illustrating embodiments of a method.

FIG. 3 is a signaling diagram illustrating embodiments of a method.

FIG. 4 is a flow chart illustrating embodiments of a method in a target RAN node.

FIG. 5 is a schematic block diagram illustrating embodiments of a target RAN node.

FIG. 6 is a flow chart illustrating embodiments of a method in a target CN node.

FIG. 7 is a schematic block diagram illustrating embodiments of a target CN node.

FIG. 8 is a flow chart illustrating embodiments of a method in a used CN node.

FIG. 9 is a schematic block diagram illustrating embodiments of a used CN node.

FIG. 10 is a flow chart illustrating embodiments of a method in a subscriber node.

FIG. 11 is a schematic block diagram illustrating embodiments of a subscriber node.

FIG. 12 is a schematic block diagram illustrating embodiments of a wireless device.

FIG. 13 is a schematic block diagram illustrating embodiments of a network node.

The drawings are not necessarily to scale and the dimensions of certain features may have been exaggerated for the sake of clarity. Emphasis is instead placed upon illustrating the principle of the embodiments herein.

### DETAILED DESCRIPTION

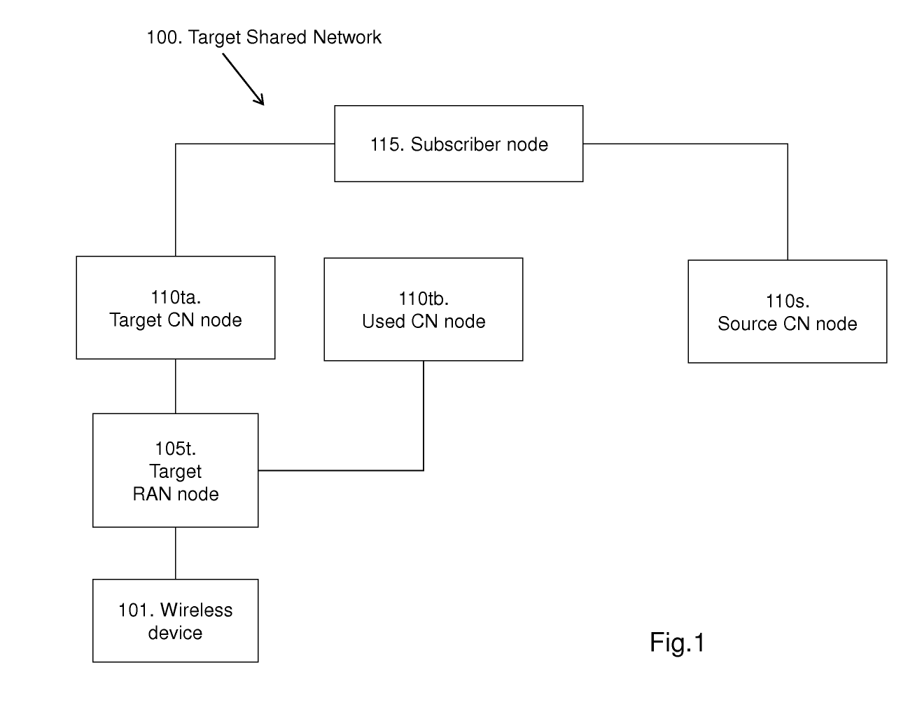

FIG. 1 depicts a target shared network 100 in which embodiments herein may be implemented. The target shared network 100 may in some embodiments apply to one or more radio access technologies such as for example GERAN or UTRAN.

After a wireless device 101 has been handed over to the target shared network 100, it is served by a target RAN node 105t. The target RAN node 105t may be a target NodeB, target base station, target BSC, target Radio Network Controller (RNC) etc. The target RAN node 305 is connected to at least one CN node in the target shared network 100. One such CN node may be a target CN node 110ta which may provide services to the wireless device 101. The target CN node 110ta may be a target MSC. In an embodiment where there are two domains and at least two operators in the target shared network 100, there are at least four CN nodes in the target shared network 100. The target CN node 110ta is located in a CN which comprises a CS and/or PS domain. The target CN node 110ta may be located in the CS domain. Another CN node in the target shared network 100 is a used CN node 110tb. The used CN node 110tb may also be referred to as a used target CN node 100tb. The used CN node 110tb may be located in another domain than the target CN node 100ta such as the PS domain. The used CN node 100tb is used in the other domain for the subscriber of the wireless device 101. The term “used” alludes to the operator and the CN node that is selected and used in the target shared network 100, not the corresponding that was used in the source network. Even though FIG. 1 illustrates two CN nodes in the target shared network 100, the skilled person will understand that the target shared network 100 may comprise any number of candidate CN nodes adapted to serve the wireless device 101 in the target shared network 100.

The wireless device 101 may be a device by which a subscriber may access services offered by an operator's network and services outside the operator's network to which the operator's RAN and CN provide access, e.g. access to the Internet. The wireless device 101 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, M2M device or any type of consumer electronic, for instance but not limited to television, radio, lighting arrangements, tablet computer, laptop or PC. The wireless device 101 may be portable, pocket storable, hand held, computer comprised, or vehicle mounted devices, enabled to communicate voice and/or data, via the radio access network, with another entity, such as another device or a server.

The wireless device 101 may be supporting or non-supporting. The 3GPP defines a supporting wireless device to be a wireless device that supports network sharing in the sense that it is able to select a CN operator as the serving operator within a shared network. The supporting wireless device may also be referred to as a network sharing supporting wireless device. A non-supporting wireless device is defined as a wireless device that does not support network sharing in the sense that it is not able to read the additional broadcast system information that is specific for network sharing. The non-supporting wireless device may also be referred to as a network sharing non-supporting wireless device.

There are two operational modes of the wireless device 101: idle mode and connected mode. In idle mode, after the wireless device 101 has been switched on, it selects a

PLMN to connect to. The wireless device 101 searches for a cell of the selected PLMN that can provide available services and camps on the selected cell. In idle mode, the wireless device 101 is identified by parameters such as IMSI, Temporary Mobile Subscriber Identity (TMSI) and Packet Temporary Mobile Subscriber Identity (P-TMSI). The RAN does not have any information about idle wireless devices, i.e. information such as location, bearer information etc. The wireless device 101 stays in idle mode until it transmits a request to establish a radio connection. In connected mode, the wireless device 101 transmits and receives data. The wireless device 101 leaves the connected mode and returns to idle mode when the radio connection is released or at radio connection failure. In connected mode, the RAN has information about the connected wireless devices, i.e. information such as location and bearer information etc.

The target shared network 100 comprises a subscriber node 115 which may be a HSS or a HLR. The HSS is a database comprising subscription related information. The HSS performs authentication and authorization of the wireless device 101, and can provide information about the subscriber's location and Internet Protocol (IP) information. The HSS comprises the IMSI. HLR is similar to the HSS and is a database that comprises details of each wireless device 101 that is authorized to use the CN. The HLR comprises the IMSI. In some embodiments, the subscriber node 115 is referred to as a subscriber database node.

Before the wireless device 101 was handed over to the target shared network 100, it was located in a source network (not shown) and served by a source CN node 110s. The source CN node 110s may be a source MSC or a source SGSN.

The letter t in the reference numbers for the entities shown in FIG. 1 refers to the target shared network 100 and the letter s refers to the source network.

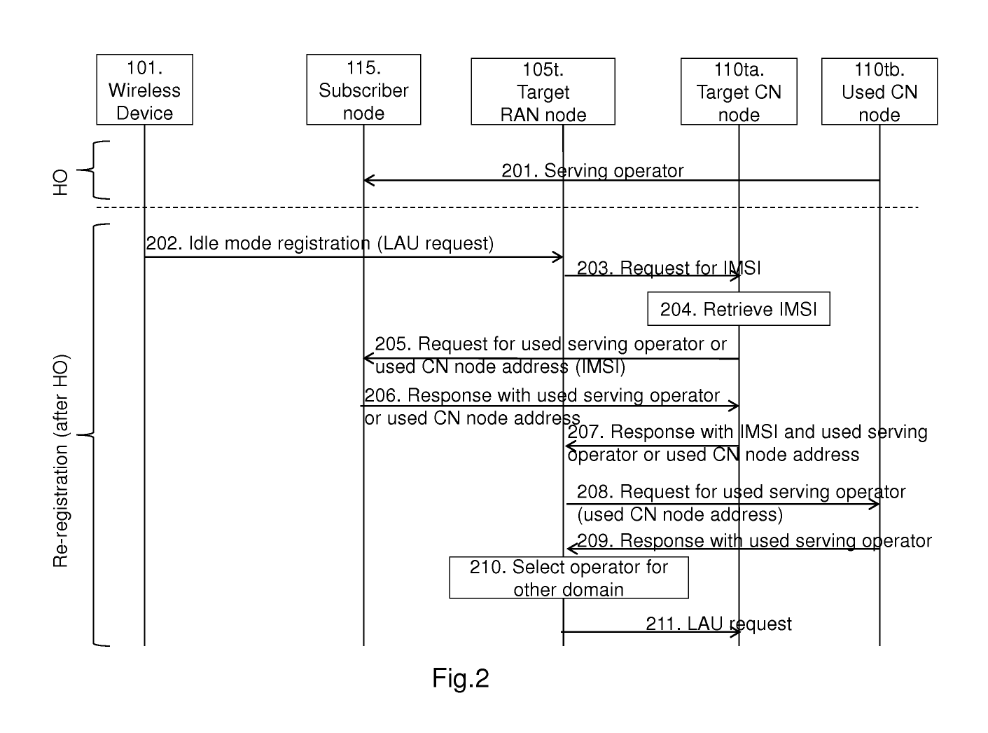

The method for CSPS coordination, according to some embodiments will now be described with reference to the signaling diagram depicted in FIG. 2. Step 201 relates to the handover of the wireless device 101 and steps 202-211 relate to Idle mode re-registration of the wireless device 101 after the handover. The handover may be a PS handover. As mentioned previously, the target shared network 100 may be for example GERAN or UTRAN. The method comprises the following steps, which steps may be performed in any suitable order:

Step 201

During handover of the wireless device 101 from the source network to the target shared network 100, the used CN node 110tb, e.g. a SGSN, transmits information indicating the serving operator which serves the wireless device 101 in the target network. This information is transmitted to the subscriber node 115, e.g. HSS or HLR.

The dotted line in FIG. 2 illustrates the end of the handover procedure. Steps 202-211 are steps performed after the handover procedure, i.e. when the wireless device 101 performs Idle mode signaling in the non-registered domain.

Step 202

The wireless device 101 is in idle mode and performs registration to the target shared network 100. The wireless device 101 does this by transmitting a LAU request to the target RAN node 105t. This may also be seen as the wireless device 101 performing the registration after the handover procedure in step 201.

The received LAU request may comprise a common PLMN. The common PLMN is in the LAU request because the common PLMN is the only PLMN which a non-supporting wireless device 101 can read.

Step 203

The target RAN node 105t, e.g. a BSC, request the IMSI from a target CN node 110ta in the same domain (CS domain) that the incoming mobility message LAU Request from step 202 is considered for. There may be at least two such target CN nodes, one for each operator. There may be more than two such target CN nodes in case of several sharing operators or if there is support for an MSC pool. This request may be to any of the CN nodes in the CS domain, i.e. the non-registered domain, of the target shared network 100, but it is the target CN node 110ta which receives the request for the IMSI in this example.

Step 204

The target CN node 110ta retrieves the IMSI either by requesting the source CN node 110s or by fetching the IMSI directly from the wireless device 101.

Step 205

The target CN node 110ta requests the subscriber node 115, e.g. HLR or HSS, for this wireless device 101 subscriber of either the serving operator or the used CN node 100tb for the other domain (PS domain) compared to the domain which the incoming LAU request was considered for. The IMSI which was retrieved in step 204 is included in this request.

Step 206

The subscriber node 115, e.g. the HLR or the HSS responds to the target CN node 110ta with the used serving operator or the address of the used CN node 110tb, depending on the available information in the subscriber node 115. The IMSI may be included in the response.

Step 207

The target CN node 110ta, e.g. the MSC, responds back to the target RAN node 105t, e.g. the BSC, including the IMSI and either the used serving operator or the used CN node 110tb (the address).

Step 208

If the source RAN node 105t, e.g. the BSC, have got the used CN node address in step 207, the source RAN node 105t requests information indicating the used serving operator for the other domain from this used CN node 110tb. The request includes the IMSI and a request for the information indicating the used serving operator

Step 209

The used CN node 110tb transmits a response to the source RAN node 105t, e.g. the BSC, including information indicating the used serving operator.

Step 210

The target RAN node 105t, e.g. the BSC, selects the operator for the domain (CS) that the incoming mobility message (LAU Request or RAU Request) in step 202 as the same as indicated for the other domain, the domain of the used serving operator.

Step 211

The target RAN node 105t, e.g. the BSC, uses the selected serving operator and sends the incoming LAU Request to such a target CN node 110ta representing this serving operator in case of MOON (the target CN node 110ta represents an operator). In case of GWCN, the target RAN node 105, e.g. the BSC, includes the selected serving operator to the target CN node 110ta (which represents all the sharing operators). The incoming LAU Request from step 202 is sent to this GWCN target CN node 110ta. In the example of FIG. 2, it is the target CN node 110ta which the incoming LAU request is sent to. The LAU request may comprise the common PLMN.

Note that in case the subscriber node 115, e.g. the HLR or the HSS, sends the used serving operator to a CN node on request (as described above), this information shall be included to the subscriber node 115, the HLR or the HSS, when this information is available in the CN node from the other domain.

A location area, as mentioned above, comprises one or more radio cells and is identified with a unique number referred to as location area code. A routing area is the PS domain corresponding item to a location area. A routing area may be a subdivision of a location area and there may be at least one routing area within the corresponding location area. A routing area is identified by a Routing Area Identifier (RAI) and a location area is identified by a Location Area Identifier (LAI). A PLMN may be divided into location areas and routing areas. A change from routing area to routing area, referred to as a routing area update, is done in a very similar way to a change from location area to location area. The main difference is that the SGSN is the involved node.

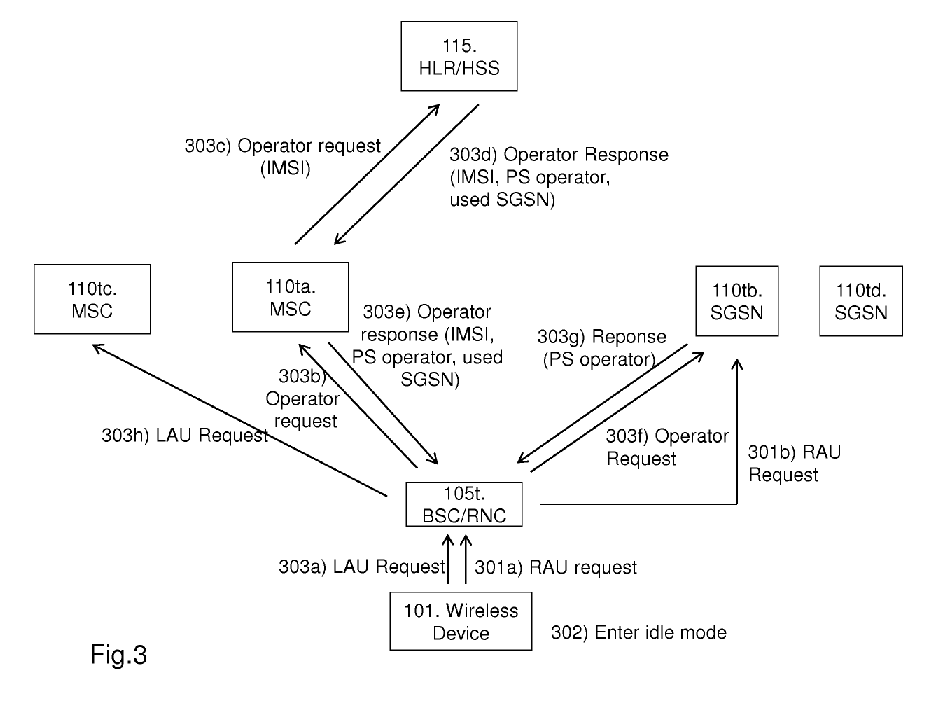

An example of the above described method is described in FIG. 3. The example in FIG. 3 illustrates a PS handover for non-DTM in a MOON network. Non-DTM is present if either or both of the wireless device 101 and the BSC do not support DTM. Combined procedures are not used in the illustrated example in FIG. 3. The wireless device 101 in FIG. 3 may be non-supporting and may be exemplified by a UE, however any types of device as described previously is applicable. The target RAN node 105t may be a BSC or a RNC, the target CN node 110ta is exemplified by a MSCs and the used CN node 110tb is exemplified by a SGSNs. The target shared network 100 seen in FIG. 3 comprises two additional CN nodes, i.e. the MSC 110tc and the SGSN 110td, both which are located in the target shared network 100. The target shared network 100 may comprise any other suitable number of CN nodes. The subscriber node 115 may be a HLR or a HSS. The MSCs and the SGSNs seen on FIG. 3 is in the target shared network 100, not the source side. The method comprises the following three main steps:

301) PS handover and RAU.

302) The wireless device 101 enters idle mode.

303) The wireless device 101 performs a LAU.

Note that step 301 with the RAU request is performed during PS handover, and steps 302-303 are performed after the PS handover.

In the following, each of the steps 301-303 will be described in more detail. The method comprises the following steps, which steps may be performed in any suitable order.

Step 301a)

This is a substep of step 301. During PS handover, the wireless device 101 transmits a RAU request comprising a common PLMN to the BSC 105t.

Step 301b)

This is a substep of step 301. During PS handover, the BSC 105t transmits the RAU request comprising the common PLMN to the SGSN 110tb. In the current 3GPP standard, the PS operator is selected by the source RAN node when the PS handover is triggered

Step 302)

The wireless device 101 enters idle mode. The wireless device 101 may enter idle mode after the PS handover is finished or after a transmission of uplink and downlink data is finished, i.e. after steps 301a and 301b.

Step 303a)

This step corresponds to step 202 in FIG. 2. This is a substep of step 303. The wireless device 101 transmits a LAU Request to the BSC 105t. The LAU Request may comprise a common PLMN.

Step 303b)

This step corresponds to step 203 in FIG. 3. This is a substep of step 303. When the LAU Request is received in the BSC 105t, the BSC 105t requests the IMSI and/or the used SGSN for this subscriber/wireless device 101 from the MSC 110ta (target CN node 110ta).

In the current 3GPP standard, the CS operator is selected by the BSC 105t at the target side using MOON redirection (the IMSI is retrieved by the MSC 110t).

Step 303c)

This step corresponds to step 204 and step 205 in FIG. 2. This is a substep of step 303. The MSC 110ta (target CN node 110ta) retrieves the IMSI and transmits, to the HLR or HSS 115, a request for either the used SGSN (used CN node 110tb) for the subscriber/wireless device 101 or the used serving operator, e.g. the PS operator, for the subscriber/wireless device 101. The request comprises the IMSI.

Step 303d)

This step corresponds to step 206 in FIG. 2. This is a substep of step 303. The HLR or HSS 115 transmits an operator response to the MSC 110ta comprising information indicating the IMSI and at least one of the PS operator (used serving operator) and the used SGSN (used CN node 110tb).

Step 303e)

This step corresponds to step 207 in FIG. 2. This is a substep of step 303. The MSC 110ta transmits a response to the BSC 105t comprising the IMSI and at least one of the PS operator (used serving operator) and the used SGSN (used CN node 110tb).

Step 303f)

This step corresponds to step 208 in FIG. 2. This is a substep of step 303. The BSC 105t transmits, to the SGSN 110tb, a request for the used serving operator, e.g. the PS operator, for the subscriber/wireless device 101. The request comprises the IMSI. This step 303f) is performed if the response in step 303e) comprises the used SGSN (not the used serving operator)

Step 303g)

This step corresponds to step 209 in FIG. 2. This is a substep of step 303. The SGSN 110tb sends a response to the BSC 105t. The response comprises the requested used serving operator, e.g. the PS operator for the subscriber/wireless device 101.

Step 303h)

This step corresponds to step 210 and step 211 in FIG. 2. This is a substep of step 303. Based on the information in the response in step 303e) and optionally step 303g), the BSC 105t knows which MSC 110t that should receive the incoming LAU request from step 303a. Based on this, the BSC 105t forwards the incoming LAU request with the common PLMN to the correct MSC 110tc. The BSC 105t selects CS operator=PS operator, and sends the LAU request to the MSC 110tc representing this operator.

With the current 3GPP standard, there is a problem that no CSPS coordination is achieved since there is no RAU after LAU when the RAI is not changed. With the current 3GPP standard, this requires synchronization between the operator selection in the source CN/RAN (the PS operator) and target BSC (the CS operator). With the embodiments herein, this problem is solved by that when the LAU Request (step 303a) is received in the BSC 105t, the BSC 105t requests the IMSI, the used SGSN 110tb for this subscriber or the used operator for this subscriber from the MSC 110ta (step 303b). The MSC 110ta requests the HLR or HSS 115 of either the used SGSN 110tb for the subscriber or the used PS operator for the subscriber (step 303c). The HLR or HSS 115 responds to the MSC 110ta (step 303d). The MSC 110ta transfers this information to the BSC 105t (step 303e). The BSC 105t selects the CS operator =PS operator and sends a LAU request (step 303f) to the MSC 110tc representing this operator.

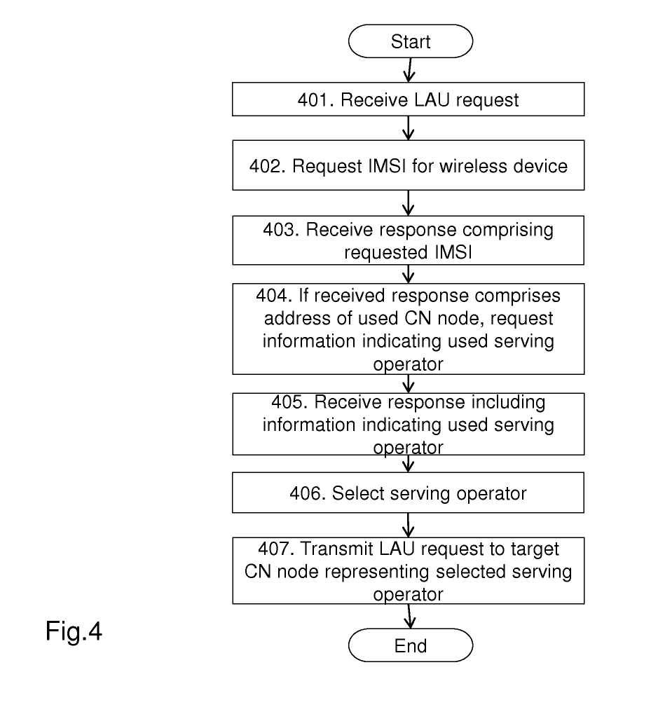

The method described above will now be described seen from the perspective of the target RAN node 105t. FIG. 4 is a flowchart describing the present method in target RAN node 105t for handling selection of a serving operator for a wireless device 101 which has been handed over from a source network to the target shared network 100. The wireless device 101 may be in idle mode after having been handed to the target shared network 100. The method comprises the following steps to be performed by the target RAN node 105t, which steps may be performed in any suitable order than described below:

Step 401

This step corresponds to step 202 in FIG. 2 and step 303a in FIG. 3. In some embodiments, when the wireless device 101 performs registration to the target shared network 100 after handover, the target RAN node 105t receives the LAU request or the RAU request from the wireless device 101. The received LAU request or RAU request may comprise a common PLMN.

Step 402

This step corresponds to step 203 in FIG. 2 and step 303b in FIG. 3. When the wireless device 101 has been handed over to the target shared network 100, the target RAN node 105t requests an IMSI for the wireless device 101 from a target CN node 110ta in a same domain that an incoming mobility message is considered for. The incoming mobility message may be a LAU request. The domain that the incoming mobility message is considered for may be the CS domain.

Step 403

This step corresponds to step 207 in FIG. 2 and step 303e in FIG. 3. The target RAN node 105t receives a response comprising the requested IMSI from the target CN node 110ta. The response further comprises either a used serving operator which served the wireless device 101 in the source network or an address of a used CN node.

Step 404

This step corresponds to step 208 in FIG. 2. In some embodiments, if the received response comprises the address of the used CN node, the target RAN node 105t requests information indicating the used serving operator from the used CN nodes which the address indicates.

Step 405

This step corresponds to step 209 in FIG. 2. In some embodiments, the target RAN node 105t receives a response from the used CN nodes including information indicating the used serving operator.

Step 406

This step corresponds to step 210 in FIG. 2 and step 303e in FIG. 3. The target RAN node 105t selects the serving operator for the domain which the incoming mobility message is considered for to be the same as indicated for the used serving operator.

Step 407

This step corresponds to step 211 in FIG. 2 and step 303f in FIG. 3. In some embodiments, the target RAN node 105 transmits the LAU request or the RAU request to the target CN node 110ta representing the selected serving operator, i.e. the LAU or RAU request from step 401. The LAU request message comprises the common PLMN.

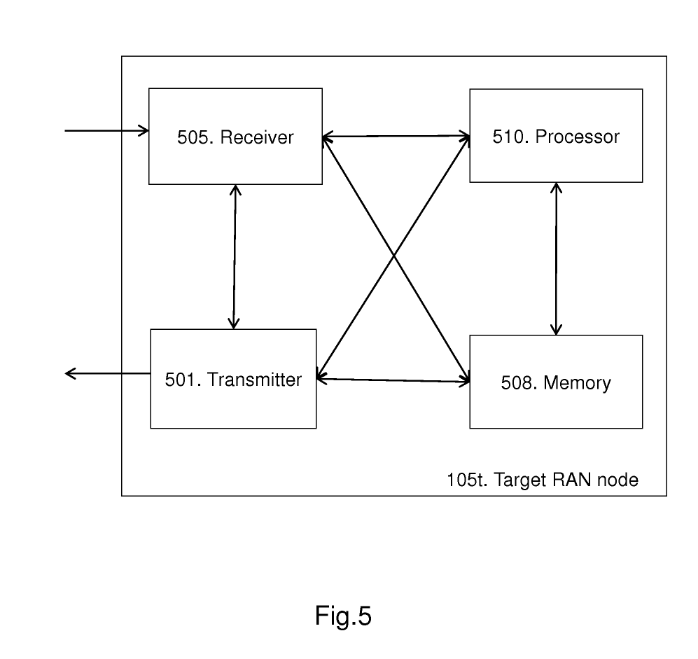

To perform the method steps shown in FIGS. 2, 3 and 4 the target RAN node 105t comprises an arrangement as shown in FIG. 5. The target RAN node 105t is adapted to handle selection of the serving operator for the wireless device 101 which has been handed over from the source network to the target shared network 100. The wireless device 101 may be in idle mode in a CS domain after having been handed over to the target shared network 100. The wireless device 101 may be a non-supporting wireless device. The target RAN node 105t may be a target NodeB, target base station, target BSC, target RNC etc.

The target RAN node 105t comprises a transmitter 501 which is adapted to, when the wireless device 101 has been handed over to the target shared network 100, request the IMSI for the wireless device 101 from the target CN node 110ta in the same domain that the incoming mobility message is considered for. The transmitter 501 may be further adapted to, if the received response comprises the address of the used CN node 110tb, request information indicating the used serving operator from the used CN node 110tb which the address indicates. The request may comprise the IMSI for the wireless device 101. The transmitter 501 may be further adapted to transmit the LAU request to the target CN node 110ta representing the selected serving operator. The incoming mobility message may be a LAU request. The domain that the incoming mobility message is considered for may be a CS domain and the other domain may be a PS domain.

The target RAN node 105t may comprise a receiver 505 which may be adapted to receive registration after handover from the wireless device 101. The receiver 501 may be further adapted to receive a response from a target CN node 110ta comprising the IMSI, and the serving operator or the CN address. The receiver 505 is adapted to receive, the response comprising the requested IMSI from the target CN node 110ta. The response further comprises either the used serving operator or the address of the used CN node 110tb. The used serving operator and the used CN node 110tb are used in another domain than the domain that the incoming mobility message is considered for. The receiver 505 may be further adapted to receive a response from the used CN node 110tb including information indicating the used serving operator which serves the wireless device 101 in the other domain. The receiver 505 may be further adapted to, when the wireless device 101 performs idle mode registration to the target shared network 100 after handover, receive a LAU request from the wireless device 101.

The target RAN node 105t may further comprise a memory 508 comprising one or more memory units. The memory 508 is arranged to be used to store data, received data streams, power level measurements, IMSI, CN node address, information indicating serving operator, requests, responses, information indicating CS domain and PS domain, information related to handover, LAU, RAU, threshold values, time periods, configurations, scheduling's, and applications to perform the methods herein when being executed in the target RAN node 105t.

The target RAN node 105t comprises a processor 510 adapted to select the serving operator for the domain that the incoming mobility message is considered for to be the same as indicated for the other domain.

Those skilled in the art will also appreciate that the receiver 505 and the transmitter 501 described above may refer to a combination of analog and digital circuits, and/or one or more processors configured with software and/or firmware, e.g. stored in a memory, that when executed by the one or more processors such as the processor 510. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

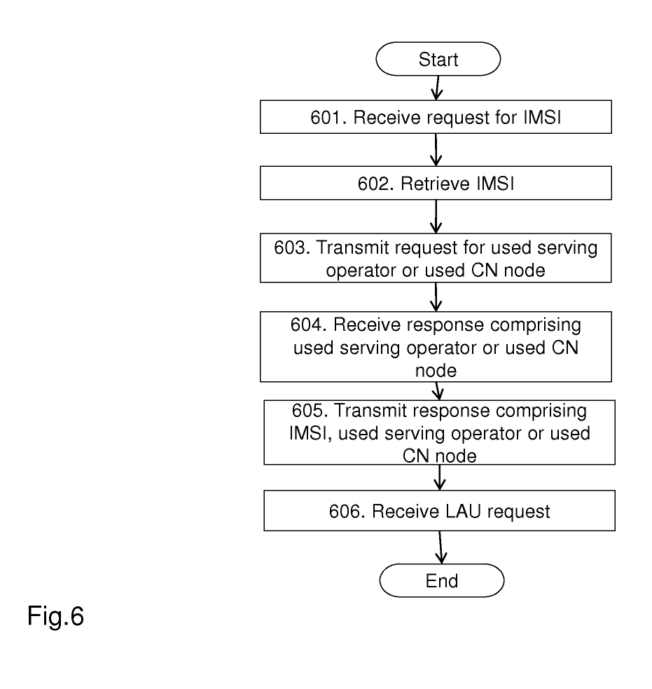

The method described above will now be described seen from the perspective of the target CN node 110ta. FIG. 6 is a flowchart describing the present method in target CN node 110ta for handling selection of the serving operator for a wireless device 101 which has been handed over from the source network to the target shared network 100. The method comprises the following steps to be performed by the target CN node 110ta, which steps may be performed in any suitable order than described below:

Step 601

This step corresponds to step 203 in FIG. 3 and step 303b in FIG. 3. When the wireless device 101 has been handed over to the target shared network 100, the target CN node 110ta receives, from the target RAN node 105t, a request for the IMSI for the wireless device 101.

Step 602

This step corresponds to step 204 in FIG. 2 and step 303c in FIG. 3. The target CN node 110ta retrieves the IMSI.

Step 603

This step corresponds to step 205 in FIG. 2 and step 303c in FIG. 3. The target CN node 110ta transmits, to the subscriber node 115, a request for a used serving operator which served the wireless device 101 in the source network or an address of a used CN node. The request comprises the IMSI.

Step 604

This step corresponds to step 206 in FIG. 2 and step 303d in FIG. 3. The target CN node 110ta receives a response comprising the used serving operator which served the wireless device 101 in the source network or the address of the used CN node.

Step 605

This step corresponds to step 207 in FIG. 2 and step 303e in FIG. 3. The target CN node 110ta transmits the response comprising the IMSI to the target RAN node 105t. The response further comprises information indicating the used serving operator which served the wireless device 101 in the source network or the address of the used CN node.

Step 606

This step corresponds to step 211 in FIG. 2 and step 303f in FIG. 3. In some embodiments, if the target CN node 110ta represents a selected serving operator, the target CN node 110ta receives a LAU request or a RAU request from the target RAN node 105t. The LAU request or the RAU request comprises a common PLMN.

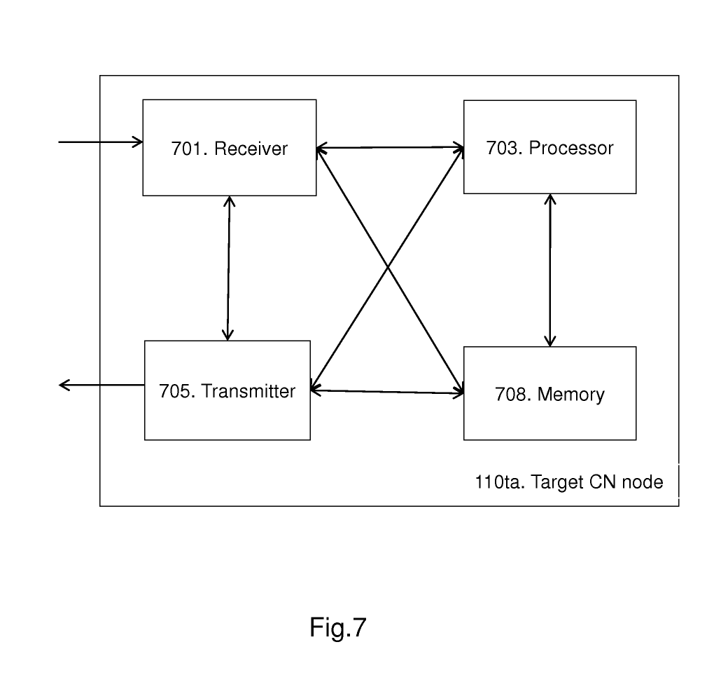

To perform the method steps shown in FIGS. 2, 3 and 6 the target CN node 110ta comprises an arrangement as shown in FIG. 7. The target CN node 110ta is adapted to handle selection of the serving operator for the wireless device 101 which has been handed over from the source network to the target shared network 100. The target CN node 110ta is in the same domain as the incoming mobility message is considered for by the target RAN node 105t. The target CN node 110ta may be a SGSN or a MSC.

The target CN node 110ta comprises a receiver 701 which is be adapted to, when the wireless device 101 has been handed over to the target shared network 100, receive, from the target RAN node 105t, a request for the IMSI for the wireless device 101. The receiver 701 is further adapted to receive a response from the subscriber node 115 comprising information indicating the used serving operator or the address of the used CN node 110tb. The receiver 701 may be further adapted to, when the target shared network 100 is a MOCN, receive a LAU request from the target RAN node 105t. The target CN node 110ta represents a selected serving operator. The receiver 701 may be further adapted to, when the target shared network 100 is a GWCN, receive a LAU request from the target RAN node 105t. The LAU request comprises a selected serving operator. The target CN node 110ta represents all sharing operators in case of GWCN.

The target CN node 110ta comprises a processor 703 adapted to retrieve the IMSI.

The target CN node 100ta comprise a transmitter 705 adapted to transmit, to the subscriber node 115, a request for a used serving operator or an address of a used CN node 110tb. The request comprises the IMSI. The serving operator and the used CN node 110tb is for another domain than the domain that the incoming mobility message is considered for. The transmitter 705 is further adapted to transmit the response comprising the IMSI to the target RAN node 105t. The response further comprises information indicating the used serving operator or the address of the used CN node 110tb.

The target CN node 110ta may further comprise a memory 708 comprising one or more memory units. The memory 708 is arranged to be used to store data, received data streams, power level measurements, IMSI, CN node address, information indicating serving operator, requests, responses, information indicating CS domain and PS domain, information related to handover, threshold values, time periods, configurations, scheduling's, and applications to perform the methods herein when being executed in the target CN node 110ta.

Those skilled in the art will also appreciate that the receiver 701 and the transmitter 705 described above may refer to a combination of analog and digital circuits, and/or one or more processors configured with software and/or firmware, e.g. stored in a memory, that when executed by the one or more processors such as the processor 703. One or more of these processors, as well as the other digital hardware, may be included in a single ASIC, or several processors and various digital hardware may be distributed among several separate components, whether individually packaged or assembled into a SoC.

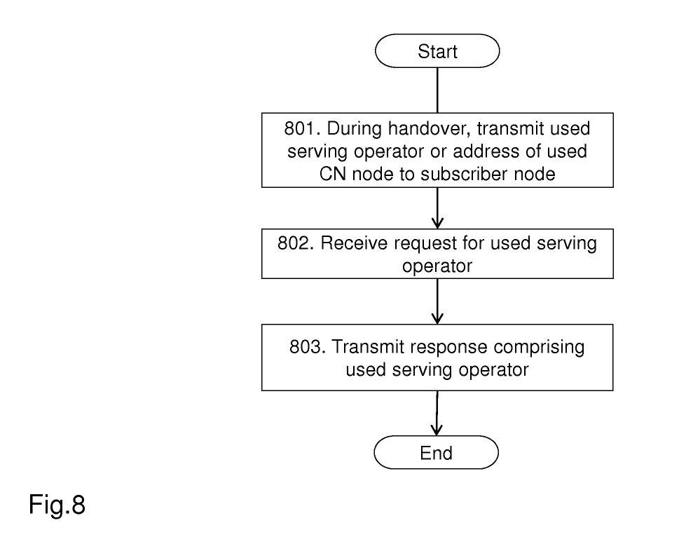

The method described above will now be described seen from the perspective of the used CN node 110tb. FIG. 8 is a flowchart describing the present method in the used CN node 110tb handling selection of the serving operator for the wireless device 101 which has been handed over from the source network to the target shared network 100. The used CN node 110tb is used in another domain than what the incoming mobility message is considered for by a target RAN node 105t. The incoming mobility message may be a LAU request. The domain that the incoming mobility message is considered for may be a CS domain. The other domain may be PS domain. The method comprises the following steps to be performed by the used CN node 110tb, which steps may be performed in any suitable order than described below:

Step 801

This step corresponds to step 201 in FIG. 2. In some embodiments, the used CN node 110tb transmits, to the subscriber node 115, the used serving operator or the address of the used CN node 100tb during the handover of the wireless device 101 to the target shared network 100.

Step 802

This step corresponds to step 208 in FIG. 2 and step 303f in FIG. 3. The used CN node 110tb receives, from the RAN node 105t, a request for information indicating a used serving operator. The used serving operator is used in the other domain. The request may include the IMSI for the wireless device 101.

Step 803

This step corresponds to step 209 in FIG. 2 and step 303g in FIG. 3. The used CN node 110tb transmits a response to the RAN node 105t including information indicating the used serving operator which serves the wireless device 101 in the other domain.

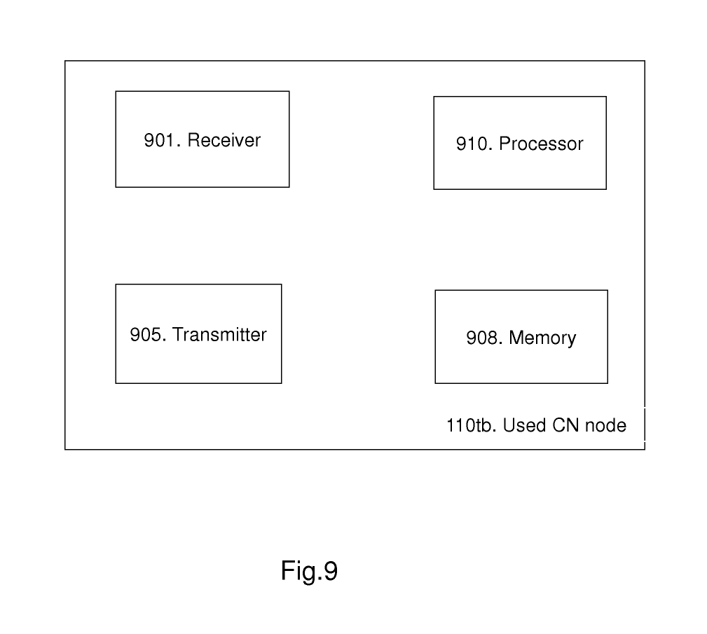

To perform the method steps shown in FIGS. 2, 3 and 8 for handling selection of the serving operator for the wireless device 101 which has been handed over from the source network to the target shared network 100, the used CN node 110tb comprises an arrangement as shown in FIG. 9. The used CN node 110tb is used in another domain than what an incoming mobility message is considered for by a target RAN node 105t. The incoming mobility message may be a LAU request. The domain that the incoming mobility message is considered for may be a CS domain. The other domain may be a PS domain.

The used CN node 110tb comprises a receiver 901 which is adapted to receive, from the RAN node 105t, a request for information indicating a used serving operator. The used serving operator is used in the other domain. The request may include an IMSI for the wireless device 101.

The used CN node 110tb comprises a transmitter 905 which is adapted to transmit a response to the RAN node 105t including information indicating the used serving operator which serves the wireless device 101 in the other domain. The transmitter 905 may be further adapted to transmit, to the subscriber node 115, the used serving operator or the address of the used CN node 100tb during the handover of the wireless device 101 to the target shared network 100.

The used CN node 110tb may further comprise a memory 908 comprising one or more memory units. The memory 908 is arranged to be used to store data, received data streams, power level measurements, IMSI, CN node address, information indicating serving operator, requests, responses, information indicating CS domain and PS domain, information related to handover, threshold values, time periods, configurations, scheduling's, and applications to perform the methods herein when being executed in the used CN node 110tb.

The used CN node 110tb may comprise a processor 910 which will be described in more detail below.

Those skilled in the art will also appreciate that the receiver 901 and the transmitter 905 described above may refer to a combination of analog and digital circuits, and/or one or more processors configured with software and/or firmware, e.g. stored in a memory, that when executed by the one or more processors such as the processor 910. One or more of these processors, as well as the other digital hardware, may be included in a single ASIC, or several processors and various digital hardware may be distributed among several separate components, whether individually packaged or assembled into a SoC.

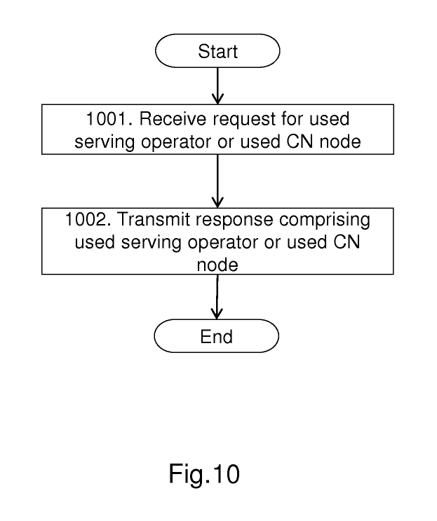

The method described above will now be described seen from the perspective of the subscriber node 115. FIG. 10 is a flowchart describing the present method in the subscriber node 115 for handling selection of the serving operator for the wireless device 101 which has been handed over from the source network to the target shared network 100. The method comprises the following steps to be performed by the subscriber node 115, which steps may be performed in any suitable order than described below:

Step 1001

This step corresponds to step 205 in FIG. 2 and step 303c in FIG. 3. The subscriber node 115 receives, from the target CN node 110ta, a request for a used serving operator which served the wireless device 101 in the source network or an address of a used CN node. The request comprises the IMSI.

Step 1002

This step corresponds to step 206 in FIG. 2 and step 303d in FIG. 3. The subscriber node 115 transmits, to the target CN node 110ta, a response comprising the used serving operator which served the wireless device 101 in the source network or the address of the used CN node. The subscriber node 115 may have received the used serving operator which served the wireless device 101 in the source network or the address of the used CN node during the handover of the wireless device 101 to the target shared network 100.

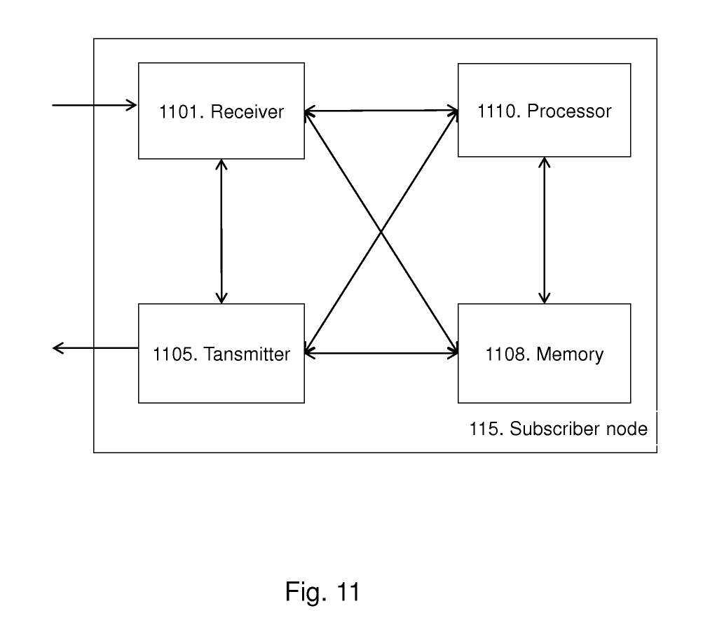

To perform the method steps shown in FIGS. 2, 3 and 9 the subscriber node 115 comprises an arrangement as shown in FIG. 11. The subscriber node 115 is adapted to handle selection of the serving operator for the wireless device 101 which has been handed over from the source network to the target shared network 100. The subscriber node 115 may be a HLR or a HSS.

The subscriber node 115 comprises a receiver 1101 which is adapted to receive, from a target CN node 110ta, a request for a used serving operator or an address of a used CN node 110tb. The request comprises an IMSI for the wireless device 101. The used serving operator and the used CN node 110tb is for another domain than the domain which an incoming mobility message is considered for by a target RAN node 105. In some embodiments, the subscriber node 115 has received the used serving operator or the address of the used CN node from the used CN node 110tb during the handover of the wireless device 101 to the target shared network 100. The incoming mobility message may be a LAU request. The domain that the incoming mobility message is considered for may be a CS domain. The other domain may be a PS domain.

The subscriber node 115 comprises a transmitter 1105 which may be adapted to transmit a response to the used CN node 110tb. The response comprises the used serving operator or the address of the used CN node 110tb of the other domain.

The subscriber node 115 comprises a memory 1108 comprising one or more memory units. The memory 908 is arranged to be used to store data, received data streams, power level measurements, IMSI, CN node address, information indicating serving operator, threshold values, time periods, configurations, schedulings, and applications to perform the methods herein when being executed in the subscriber node 115.

The subscriber node 115 may comprise a processor 1110 which will be described in more detail below.

Those skilled in the art will also appreciate that the receiver 1101 and the transmitter 1105 described above may refer to a combination of analog and digital circuits, and/or one or more processors configured with software and/or firmware, e.g. stored in a memory, that when executed by the one or more processors such as the processor 1110. One or more of these processors, as well as the other digital hardware, may be included in a single ASIC, or several processors and various digital hardware may be distributed among several separate components, whether individually packaged or assembled into a SoC.

The embodiments herein may be implemented through one or more processors, such as a processor 510 in the target RAN node 105t depicted in FIG. 5, the processor 703 in the target CN node 110ta depicted in FIG. 7, the processor 910 in the used CN node 110tb and the processor 1110 in the subscriber node 115 depicted in FIG. 11, together with computer program code for performing the functions of the embodiments herein. The processors may be for example a Digital Signal Processor (DSP), ASIC processor, Field-programmable gate array (FPGA) processor or micro processor. The program code mentioned above may also be provided as a computer program product, for instance in the form of a data carrier carrying computer program code for performing the embodiments herein when being loaded into the subscriber node 115 and/or target RAN node 105t and/or the target CN node 110ta and/or the used CN node 110tb. One such carrier may be in the form of a CD ROM disc. It is however feasible with other data carriers such as a memory stick. The computer program code can furthermore be provided as pure program code on a server and downloaded to the subscriber node 115 and/or target RAN node 105t and/or the target CN node 110ta and/or the used CN node 110tb.

Some example implementations of the embodiments illustrated above will now be described.

The described embodiments may be implemented in any appropriate type of communication system supporting any suitable communication standards and using any suitable components, particular embodiments of the described solutions may be implemented in a network, such as that illustrated in FIG. 1.

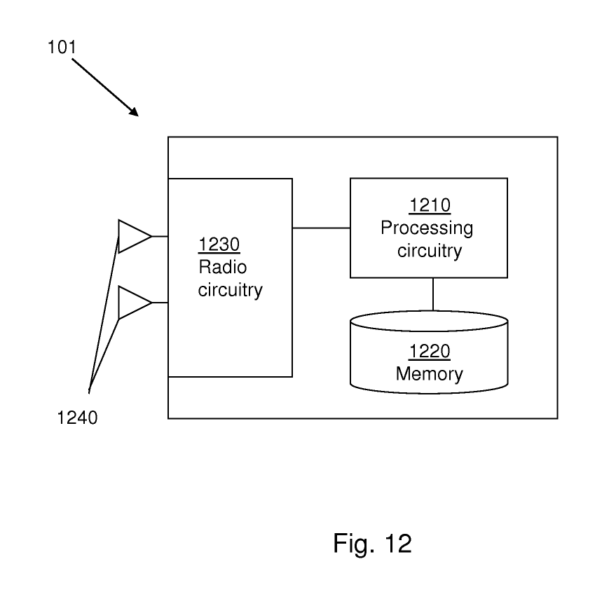

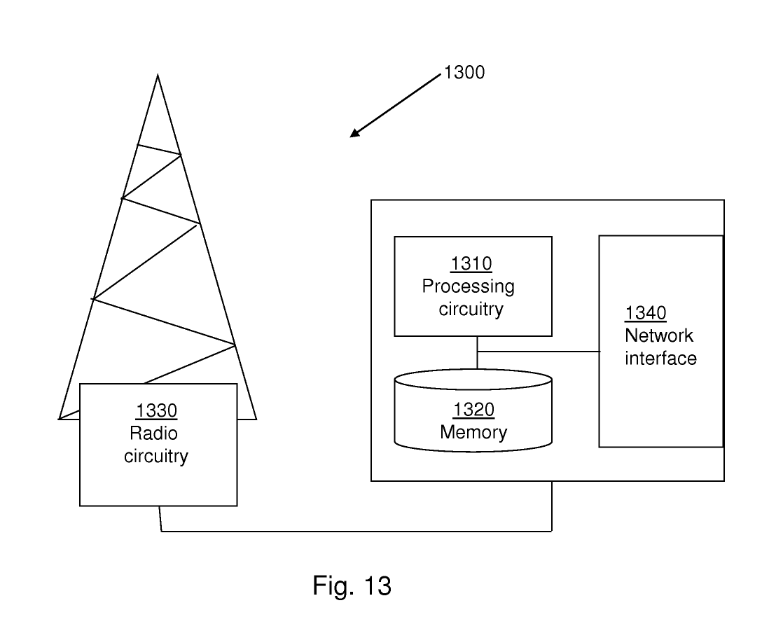

The example network may further include any additional elements suitable to support communication between wireless devices or between a wireless device and another communication device, such as a landline telephone. Although the illustrated wireless device may represent a communication device that includes any suitable combination of hardware and/or software, this wireless device may, in particular embodiments, represent a device such as the example wireless device 101 illustrated in greater detail by FIG. 12. Similarly, although the illustrated network nodes may represent network nodes that includes any suitable combination of hardware and/or software, these network nodes may, in particular embodiments, represent devices such as the example network node 1300 illustrated in greater detail by FIG. 13.

As shown in FIG. 12, the example wireless device 101 includes processing circuitry 1210, a memory 1220, radio circuitry 1230, and at least one antenna 1240. The radio circuitry 1230 may comprise RF circuitry and baseband processing circuitry (not shown). In particular embodiments, some or all of the functionality described above as being provided by mobile communication devices or other forms of wireless device 101 may be provided by the processing circuitry 1210 executing instructions stored on a computer-readable medium, such as the memory 1220 shown in FIG. 12. Alternative embodiments of the wireless device 101 may include additional components beyond those shown in FIG. 12 that may be responsible for providing certain aspects of the wireless device's functionality, including any of the functionality described above and/or any functionality necessary to support the solution described above.

As shown in FIG. 13, the example network node 1300 includes processing circuitry 1310, a memory 1320, radio circuitry 1330, network interface 1340 and at least one antenna. The processing circuitry 1310 may comprise RF circuitry and baseband processing circuitry (not shown). In particular embodiments, some or all of the functionality described above as being provided by a mobile base station, a base station controller, a relay node, a NodeB, an enhanced NodeB, and/or any other type of mobile communications node may be provided by the processing circuitry 1310 executing instructions stored on a computer-readable medium, such as the memory 1320 shown in FIG. 13. Alternative embodiments of the network node 1300 may include additional components responsible for providing additional functionality, including any of the functionality identified above and/or any functionality necessary to support the solution described above. Examples of the network node 1300 may be the target RAN node 105t, target CN node 110ta, the used CN node 110tb, subscriber node 115 etc.

Summarized:

Target RAN node 105t

When wireless device 101 has been handed over to target shared network 100:
Receive 1) LAU or 2) RAU
Transmits request for IMSI to target CN node 110ta.
Receives response from target CN node 110ta, response comprises: serving operator (alternative 1) or CN address (alternative 2)
Obtains information about serving operator if response above comprises CN address (alternative 2) from SGSN 110ta.

Target CN node 110ta

When wireless device 101 has been handed over to target shared network 100:
Receive request for IMSI from target RAN node 105t.
Retrieve IMSI.
Transmits request for serving operator using IMSI to HLR or HSS 115.
Receives response from HLR or HSS 115, response comprises: serving operator (alternative 1) or CN address (alternative 2).
Transmit response to target RAN node 105t, response comprises: serving operator (alternative 1) or CN address (alternative 2).

Subscriber node 115

During handover of the wireless device 101 to the target shared network 100:

Receive information indicating serving operator from used CN node 110tb during handover.

When wireless device 101 has been handed over to target shared network 100:
Receive request for serving operator using IMSI from target CN node 110ta.
Transmit response to target CN node 110ta, response comprises: serving operator (alternative 1) or CN address (alternative 2).

Used CN node 110tb

During HO:
Transmit information indicating serving operator serving the wireless device 101 to HSS/HLR 115 during handover.

The embodiments herein are not limited to the above described embodiments. Various alternatives, modifications and equivalents may be used. Therefore, the above embodiments should not be taken as limiting the scope of the embodiments.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

1. A method in a target Radio Access Network; (RAN) node for handling selection of a serving operator for a wireless device which has been handed over from a source network to a target shared network, the method comprising:
when the wireless device has been handed over to the target shared network, requesting, an International Mobile Subscriber Identity (IMS) for the wireless device from a target Core Network (CN) node in a same domain that an incoming mobility message is considered for;
receiving a response comprising the requested IMSI from the target CN node, wherein the response further comprises either a used serving operator or an address of a used CN node, wherein the used serving operator and the used CN node is used in another domain than the domain that the incoming mobility message is considered for; and
selecting the serving operator for the domain that the incoming mobility message is considered for to be the same as indicated for the other domain.

2. The method according to claim 1, further comprising:
if the received response comprises the address of the used CN node, requesting information indicating the used serving operator from the used CN node which the address indicates; and
receiving a response from the used CN node including
information indicating the used serving operator which serves the wireless device the other domain.

3. The method according to claim 2, wherein the request comprises the IMSI for the wireless device.

4. The method according to claim 1 further comprising:
when the wireless device performs idle mode registration to the target shared network after handover, receiving a Location Area Update (LAU) request from the wireless device; and
transmitting the LAU request to the target CN node representing the selected serving operator.

5. The method according to claim 1, wherein the incoming mobility message is a Location Area Update (LAU) request.

6. The method according to claim 1, wherein the domain that the incoming mobility message is considered for is a Circuit Switched, CS, domain; and
wherein the other domain is a Packet Switched, PS, domain.

7. The method according to claim 1, wherein the wireless device is in idle mode in a Circuit Switched, CS, domain, after having been handed over to the target shared network.

8. The method according to claim 1, wherein wireless device is a non-supporting wireless device.

9. A method in a target Core Network (CN) node for handling selection of a serving operator for a wireless device which has been handed over from a source network to a target shared network, wherein the target CN node is in a same domain as an incoming mobility message is considered for by the target RAN node; the method comprising:
when the wireless device has been handed over to the target shared network, receiving, from a target Radio Access Network, RAN, node, a request for an International Mobile Subscriber Identity (IMSI) for the wireless device;
retrieving the IMSI;
transmitting to a subscriber node a request for a used serving operator or an address of a used CN node, wherein the request comprises the IMSI, and wherein the serving operator and the used CN node is for another domain than the domain that the incoming mobility message is considered for;
receiving, from the subscriber node, a response comprising the used serving operator or the address of the used CN node; and
transmitting the response comprising the IMSI to the target RAN node, wherein the response further comprises information indicating the used serving operator or the address of the used CN node.

10. The method according to claim 9, further comprising:
when the target shared network is a Multi Operator Core Network, MOCN, receiving a Location Area Update (LAU) request from the target RAN node, wherein the target CN node represents a selected serving operator.

11. The method according to claim 9, further comprising:
when the target shared network is a Gateway Core Network, GWCN, receiving a Location Area Update (LAU) request from the target RAN node, wherein the LAU request comprises a selected serving operator, and wherein the target CN node represents all sharing operators.

12. A method in a used Core Network (CN) node for handling selection of a serving operator for a wireless device which has been handed over from a source network to a target shared network, wherein the used CN node is used in another domain than what an incoming mobility message is considered for by a target Radio Access Network (RAN) node, the method comprising:
receiving, from the RAN node, a request for information indicating a used serving operator, wherein the used serving operator is used in the other domain; and
transmitting a response to the RAN node including information indicating the used serving operator which serves the wireless device in the other domain.

13. The method according to claim 12, wherein the incoming mobility message is a Location Area Update (LAU) request.

14. The method according to claim 12, wherein the domain that the incoming mobility message is considered for is a Circuit Switched, CS, domain; and wherein the other domain is a Packet Switched, PS, domain.

15. The method according to claim 12, wherein the request includes an International Mobile Subscriber Identity (IMSI) for the wireless device.

16. The method according to claim 12, further comprising:
transmitting, to the subscriber node, the used serving operator or the address of the used CN node during the handover of the wireless device to the target shared network.

17. A method in a subscriber node for handling selection of a serving operator for a wireless device which has been handed over from a source network to a target shared network, the method comprising:
receiving, from a target Core Network (CN) node, a request for a used serving operator or an address of a used CN node, wherein the request comprises an International Mobile Subscriber Identity (IMSI) for the wireless device, and wherein the used serving operator and the used CN node is for another domain than the domain which an incoming mobility message is considered for by a target Radio Access Network (RAN) node; and
transmitting, to the target CN node, a response comprising the used serving operator or the address of the used CN node of the other domain.

18. The method according to claim 17, wherein the subscriber node has received the used serving operator or the address of the used CN node from the used CN node during the handover of the wireless device to the target shared network.

19. The method according to claim 17, wherein the incoming mobility message is a Location Area Update (LAU) request.

20. The method according to claim 17, wherein the domain that the incoming mobility message is considered for is a Circuit Switched, CS, domain; and wherein the other domain is a Packet Switched, PS, domain.

21. A target Radio Access Network (RAN) node adapted to handle selection of a serving operator for a wireless device which has been handed over from a source network to a target shared network, the target RAN node comprising:
a transmitter for requesting an International Mobile Subscriber Identity (IMSI) for the wireless device from a target Core Network (CN) node in a same domain that an incoming mobility message is considered for when the wireless device has been handed over to the target shared network;
a receiver for receiving a response comprising the requested IMSI from the target CN node, wherein the response further comprises either a used serving operator or an address of a used CN node, wherein the used serving operator and the used CN node are used in another domain than the domain that the incoming mobility message is considered for; and
a processor adapted to select the serving operator for the domain that the incoming mobility message is considered for to be the same as indicated for the other domain.

22. The target RAN node according to claim 21, wherein the transmitter is further adapted to:
if the received response comprises the address of the used CN node, request information indicating the used serving operator from the used CN node which the address indicates; and
wherein the receiver is further adapted to:
receive a response from the used CN node including information indicating
the used serving operator which serves the wireless device in the other domain.

23. The target RAN node according to claim 22, wherein the request comprises the IMSI for the wireless device.

24. The target RAN node according to claim 21, wherein the receiver is further adapted to:
when the wireless device performs idle mode registration to the target shared network after handover, receive a Location Area Update (LAU) request from the wireless device; and
wherein the transmitter is further adapted to:
transmit the LAU request to the target CN node representing the selected serving operator.

25. The target RAN node according to claim 21, wherein the incoming mobility message is a Location Area Update (LAU) request.

26. The target RAN node according to claim 21, wherein the domain that the incoming mobility message is considered for is a Circuit Switched, CS, domain; and
wherein the other domain is a Packet Switched, PS, domain.

27. The target RAN node according to claim 21, wherein the wireless device is in idle mode in a Circuit Switched, CS, domain after having been handed over to the target shared network.

28. The target RAN node according to claim 21, wherein wireless device is a non-supporting wireless device.

29. A target Core Network (CN) node for handling selection of a serving operator for a wireless device which has been handed over from a source network to a target shared network, wherein the target CN node is in a same domain as an incoming mobility message is considered for by the target RAN node; the target CN node comprising:
a receiver adapted to, when the wireless device has been handed over to the target shared network, receive, from a target Radio Access Network (RAN) node, a request for an International Mobile Subscriber Identity (IMSI) for the wireless device;
a processor adapted to retrieve the IMSI;
a transmitter adapted to transmit, to a subscriber node, a request for a used serving operator or an address of a used CN node, wherein the request comprises the IMSI, and wherein the serving operator and the used CN node is for another domain than the domain that the incoming mobility message is considered for;
wherein the receiver is further adapted to:
receive, from the subscriber node, a response comprising the used serving operator or the address of the used CN node; and
wherein the transmitter is further adapted to:
transmit the response comprising the IMSI to the target RAN node, wherein the response further comprises information indicating the used serving operator or the address of the used CN node.

30. The target CN node according to claim 29, wherein the receiver is further adapted to:
when the target shared network is a Multi Operator Core Network, MOCN, receive a Location Area Update (LAU) request from the target RAN node, wherein the target CN node represents a selected serving operator.

31. The target CN node according to claim 29, wherein the receiver is further adapted to:
when the target shared network is a Gateway Core Network, GWCN, receive a Location Area Update (LAU) request from the target RAN node, wherein the LAU request comprises a selected serving operator, and wherein the target CN node represents all sharing operators.

32. A used Core Network (CN) node for handling selection of a serving operator for a wireless device which has been handed over from a source network to a target shared network, wherein the used CN node is used in another domain than what an incoming mobility message is considered for by a target Radio Access Network (RAN) node, the used CN node comprising:
a receiver adapted to receive, from the RAN node, a request for information indicating a used serving operator, wherein the used serving operator is used in the other domain; and
a transmitter adapted to transmit a response to the RAN node
including information indicating the used serving operator which serves the wireless device in the other domain.

33. The used CN node according to claim 32, wherein the incoming mobility message is a Location Area Update (LAU) request.

34. The used CN node according to claim 32, wherein the domain that the incoming mobility message is considered for is a Circuit Switched, CS, domain; and wherein the other domain is a Packet Switched, PS, domain.

35. The used CN node according to claim 32, wherein the request includes an International Mobile Subscriber Identity (IMSI) for the wireless device.

36. The used CN node according to claim 32, wherein the transmitter is further adapted to:
transmit, to the subscriber node, the used serving operator or the address of the used CN node during the handover of the wireless device to the target shared network.

37. A subscriber node for handling selection of a serving operator for a wireless device which has been handed over from a source network to a target shared network, the subscriber node comprising:
a receiver adapted to receive, from a target Core Network (CN) node, a request for a used serving operator or an address of a used CN node, wherein the request comprises an International Mobile Subscriber Identity (IMSI) for the wireless device, and wherein the used serving operator and the used CN node is for another domain than the domain which an incoming mobility message is considered for by a target Radio Access Network (RAN) node; and
a transmitter adapted to transmit, to the target CN node, a response comprising the used serving operator or the address of the used CN node of the other domain.

38. The subscriber node according to claim 37, wherein the subscriber node has received the used serving operator or the address of the used CN node from the used CN node during the handover of the wireless device to the target shared network.

39. The subscriber node according to claim 37, wherein the incoming mobility message is a Location Area Update (LAU) request.

40. The subscriber node according to claim 37, wherein the domain that the incoming mobility message is considered for is a Circuit Switched, CS, domain; and
wherein the other domain is a Packet Switched, PS, domain.
